(19) United States
(12) Patent Application Publication
(10) Pub. No.: US 2019/0313370 A1
(43) Pub. Date: Oct. 10, 2019

(54) CRS-BASED UNICAST PDSCH TRANSMISSION IN MBSFN SUBFRAMES

(71) Applicant: QUALCOMM Incorporated, San Diego, CA (US)

(72) Inventors: Tae Min Kim, San Diego, CA (US); Lei Xiao, San Jose, CA (US); Jae Ho Ryu, San Diego, CA (US); Supratik Bhattacharjee, San Diego, CA (US); Alberto Rico Alvarino, San Diego, CA (US)

(21) Appl. No.: 16/374,344

(22) Filed: Apr. 3, 2019

Related U.S. Application Data
(60) Provisional application No. 62/653,386, filed on Apr. 5, 2018.

(51) Int. Cl. H04W 72/00

(52) U.S. Cl. CPC H04W 72/005

(57) ABSTRACT

Cell-specific reference signal (CRS)-based unicast physical downlink shared channel (PDSCH) transmission is discussed for multicast-broadcast single frequency network (MBSFN) subframes. When one or more CRS-based transmissions are scheduled during an MBSFN subframe in an MBSFN region of a transmission frame, a transmitter can transmit CRS and CRS-based unicast transmissions when no multicast-broadcast transmissions are present in the MBSFN subframe. The transmitter will signal the intent to transmit such CRS-based transmissions, thus, allowing receivers to monitor for the CRS-based transmissions, or ignore monitoring if the receivers are configured in incompatible transmission modes. Additionally, capable receivers may enable CRS-based channel estimation for those MBSFN subframes in the MBSFN region when CRS-based transmission is activated.

### CROSS-REFERENCE TO RELATED APPLICATIONS

This application claims the benefit of U.S. Provisional Patent Application No. 62/653,386, entitled, “CRS-BASED UNICAST PDSCH TRANSMISSION IN MBSFN SUBFRAMES,” filed on Apr. 5, 2018, which is expressly incorporated by reference herein in its entirety.

### BACKGROUND

### Field

Aspects of the present disclosure relate generally to wireless communication systems, and more particularly, to cell-specific reference signal (CRS)-based unicast physical downlink shared channel (PDSCH) transmission in multicast-broadcast single frequency network (MBSFN) subframes.

### Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs), also referred to as mobile entities. A UE may communicate with a base station via a downlink and an uplink. The downlink (or forward link) refers to the communication link from the base station to the UE, and the uplink (or reverse link) refers to the communication link from the UE to the base station. As used herein, a “base station” means an eNode B (eNB), a Node B, a Home Node B, or similar network component of a wireless communications system.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LIE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs. In unicast operation, each eNB is controlled so as to transmit signals carrying information directed to one or more particular subscriber UEs. The specificity of unicast signaling enables person-to-person services such as, for example, voice calling, text messaging, or video calling.

Recent LTE versions support evolved multimedia broadcast-multicast service (eMBMS) in the LTE air interface to provide the video streaming and file download broadcast delivery. For example, video streaming service is expected to be transported by the DASH (Dynamic Adaptive Streaming using HTTP) protocol over FLUTE (File Delivery over Unidirectional Transport) as defined in IETF RFC 3926 over UDP/IP packets. File download service is transported by FLUTE over UDP/IP protocols. Both high layers over IP are processed by the LTE broadcast channels in PHY and L2 (including medium access control (MAC) and radio link control (RLC) layers). However, such transport includes multiple inefficiencies which are not currently addressed in the communications industry

### SUMMARY

In one aspect of the disclosure, a method of wireless communication includes determining, by a base station, one or more cell-specific reference signal (CRS)-based downlink transmissions scheduled during a multicast-broadcast single frequency network (MBSFN) subframe of a plurality of MBSFN subframes within a transmission frame for one or more user equipments (UEs), wherein the one or more UEs are configured for a CRS-based transmission mode, and, in response to determination of no multicast-broadcast transmissions in the MBSFN subframe: transmitting, by the base station, CRS during a MBSFN region of the MBSFN subframe; and transmitting, by the base station, the one or more CRS-based downlink transmissions to the one or more UEs.

In an additional aspect of the disclosure, a method of wireless communications includes receiving, by a UE, an indicator from a serving base station, wherein the indicator identifies that CRS are to be transmitted across one of: a system bandwidth, or a portion of the system bandwidth, in a multicast-broadcast single frequency network (MBSFN) region during one or more MBSFN subframes of a plurality of MBSFN subframes of a plurality of subframes of a transmission frame, in response to the indicator being received semi-statically, one of: monitoring, by the UE, in response to the UE being configured in a CRS-based transmission mode, for downlink transmissions scheduled during the one or more MBSFN subframes; or refraining, by the UE, in response to the UE being configured in a non-CRS-based transmission mode, from attempted detection of the downlink transmissions during the one or more MBSFN subframes; or monitoring, by the UE, in response to the UE being configured in a non-CRS-based transmission mode, for the downlink transmissions scheduled during the one or more MBSFN subframes based on one of: the CRS-based fallback transmission mode or the non-CRS-based transmission mode with rate-matching around the CRS; and in response to the indicator being received dynamically, monitoring, by the UE, for the downlink transmissions scheduled during the one or more MBSFN subframes.

In an additional aspect of the disclosure, an apparatus configured for wireless communication includes means for determining, by a base station, one or more CRS-based downlink transmissions scheduled during a MBSFN subframe of a plurality of MBSFN subframes within a transmission frame for one or more UEs, wherein the one or more UEs are configured for a CRS-based transmission mode, and, in response to determination of no multicast-broadcast transmissions in the MBSFN subframe: transmitting, by the base station, CRS during a MBSFN region of the MBSFN subframe; and transmitting, by the base station, the one or more CRS-based downlink transmissions to the one or more UEs.

In an additional aspect of the disclosure, an apparatus configured for wireless communication includes means for receiving, by a UE, an indicator from a serving base station, wherein the indicator identifies that CRS are to be transmitted across one of: a system bandwidth, or a portion of the system bandwidth, in a multicast-broadcast single frequency network (MBSFN) region during one or more MBSFN subframes of a plurality of MBSFN subframes of a plurality of subframes of a transmission frame, means, executable in response to the indicator being received semi-statically, for one of: monitoring, by the UE, in response to the UE being configured in a CRS-based transmission mode, for downlink transmissions scheduled during the one or more MBSFN subframes; or for refraining, by the UE, in response to the UE being configured in a non-CRS-based transmission mode, from attempted detection of the downlink transmissions during the one or more MBSFN subframes; or for monitoring, by the UE, in response to the UE being configured in a non-CRS-based transmission mode, for the downlink transmissions scheduled during the one or more MBSFN subframes based on one of: the CRS-based fallback transmission mode or the non-CRS-based transmission mode with rate-matching around the CRS; and means, executable in response to the indicator being received dynamically, for monitoring, by the UE, for the downlink transmissions scheduled during the one or more MBSFN subframes.

In an additional aspect of the disclosure, a non-transitory computer-readable medium having program code recorded thereon. The program code further includes code to determine, by a base station, one or more CRS-based downlink transmissions scheduled during a MBSFN subframe of a plurality of MBSFN subframes within a transmission frame for one or more UEs, wherein the one or more UEs are configured for a CRS-based transmission mode, and, code, executable in response to determination of no multicast-broadcast transmissions in the MBSFN subframe: to transmit, by the base station, CRS during a MBSFN region of the MBSFN subframe; and to transmit, by the base station, the one or more CRS-based downlink transmissions to the one or more UEs.

In an additional aspect of the disclosure, a non-transitory computer-readable medium having program code recorded thereon. The program code further includes code to receive, by a UE, an indicator from a serving base station, wherein the indicator identifies that CRS are to be transmitted across one of: a system bandwidth, or a portion of the system bandwidth, in a multicast-broadcast single frequency network (MBSFN) region during one or more MBSFN subframes of a plurality of MBSFN subframes of a plurality of subframes of a transmission frame, code, executable in response to the indicator being received semi-statically, to one of: monitor, by the UE, in response to the UE being configured in a CRS-based transmission mode, for downlink transmissions scheduled during the one or more MBSFN subframes; or to refrain, by the UE, in response to the UE being configured in a non-CRS-based transmission mode, from attempted detection of the downlink transmissions during the one or more MBSFN subframes; or to monitor, by the UE, in response to the UE being configured in a non-CRS-based transmission mode, for the downlink transmissions scheduled during the one or more MBSFN subframes based on one of: the CRS-based fallback transmission mode or the non-CRS-based transmission mode with rate-matching around the CRS; and code, executable in response to the indicator being received dynamically, to monitor, by the UE, for the downlink transmissions scheduled during the one or more MBSFN subframes.

In an additional aspect of the disclosure, an apparatus configured for wireless communication is disclosed. The apparatus includes at least one processor, and a memory coupled to the processor. The processor is configured to determine, by a base station, one or more CRS-based downlink transmissions scheduled during a MBSFN subframe of a plurality of MBSFN subframes within a transmission frame for one or more UEs, wherein the one or more UEs are configured for a CRS-based transmission mode, and, executable in response to determination of no multicast-broadcast transmissions in the MBSFN subframe: to transmit, by the base station, CRS during a MBSFN region of the MBSFN subframe; and to transmit, by the base station, the one or more CRS-based downlink transmissions to the one or more UEs.

In an additional aspect of the disclosure, an apparatus configured for wireless communication is disclosed. The apparatus includes at least one processor, and a memory coupled to the processor. The processor is configured to receive, by a UE, an indicator from a serving base station, wherein the indicator identifies that CRS are to be transmitted across one of: a system bandwidth, or a portion of the system bandwidth, in a multicast-broadcast single frequency network (MBSFN) region during one or more MBSFN subframes of a plurality of MBSFN subframes of a plurality of subframes of a transmission frame, in response to the indicator being received semi-statically, to one of: monitor, by the UE, in response to the UE being configured in a CRS-based transmission mode, for downlink transmissions scheduled during the one or more MBSFN subframes; or to refrain, by the UE, in response to the UE being configured in a non-CRS-based transmission mode, from attempted detection of the downlink transmissions during the one or more MBSFN subframes; or to monitor, by the UE, in response to the UE being configured in a non-CRS-based transmission mode, for the downlink transmissions scheduled during the one or more MBSFN subframes based on one of: the CRS-based fallback transmission mode or the non-CRS-based transmission mode with rate-matching around the CRS; and in response to the indicator being received dynamically, to monitor, by the UE, for the downlink transmissions scheduled during the one or more MBSFN subframes.

The foregoing has outlined rather broadly the features and technical advantages of the present application in order that the detailed description that follows may be better understood. Additional features and advantages will be described hereinafter Which form the subject of the claims. It should be appreciated by those skilled in the art that the conception and specific aspect disclosed may be readily utilized as a basis for modifying or designing other structures for carrying out the same purposes of the present application. It should also be realized by those skilled in the art that such equivalent constructions do not depart from the spirit and scope of the present application and the appended claims. The novel features which are believed to be characteristic of aspects, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present claims.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system.

FIG. 3 is a block diagram conceptually illustrating a design of a base station/eNB and a UE configured according to one aspect of the present disclosure.

FIG. 4 is a diagram of a signaling frame illustrating an example of symbol allocation for unicast and multicast signals.

FIG. 5 is a diagram illustrating MBMS over a Single Frequency Network (MBSFN) areas within an MBSFN service area.

FIG. 6 is a block diagram illustrating components of a wireless communication system for providing or supporting MBSFN service.

FIG. 7 is a block diagram illustrating example blocks executed to implement one aspect of the present disclosure.

FIG. 8 is a block diagram illustrating example blocks executed to implement one aspect of the present disclosure.

FIG. 9 is a block diagram illustrating base station and UEs configured according to one aspect of the present disclosure.

FIG. 10 is a block diagram illustrating base station and UEs configured according to one aspect of the present disclosure.

FIG. 11 is a block diagram illustrating base station and UEs configured according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDMA, etc. UTRA and E-UTRA are part of Universal Mobile Telecommunications System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

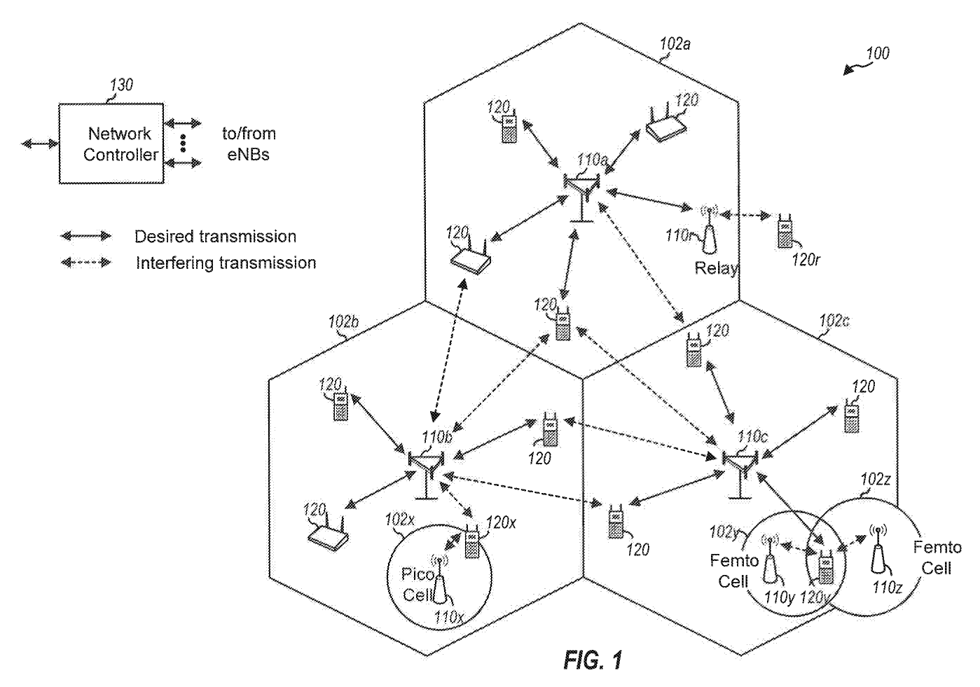

FIG. 1 shows a wireless communication network 100, which may be an LTE network. The wireless network 100 may include a number of eNBs 110 and other network entities. An eNB may be a station that communicates with the and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HNB). In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs, In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt),

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a tablet, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

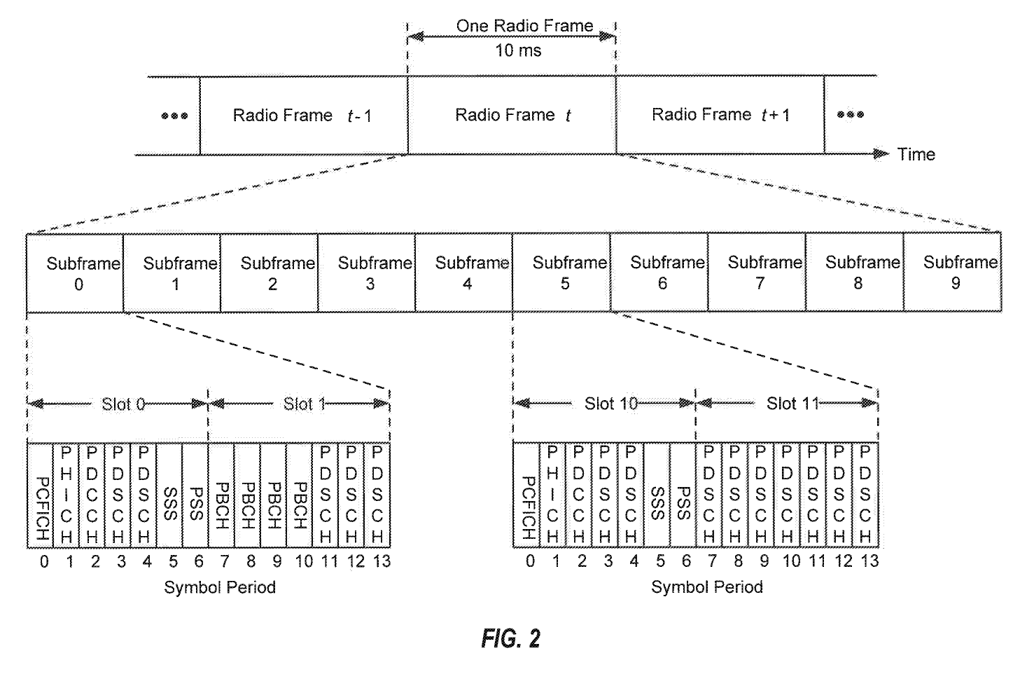

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2, The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP Technical Specification (TS) 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast mariner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

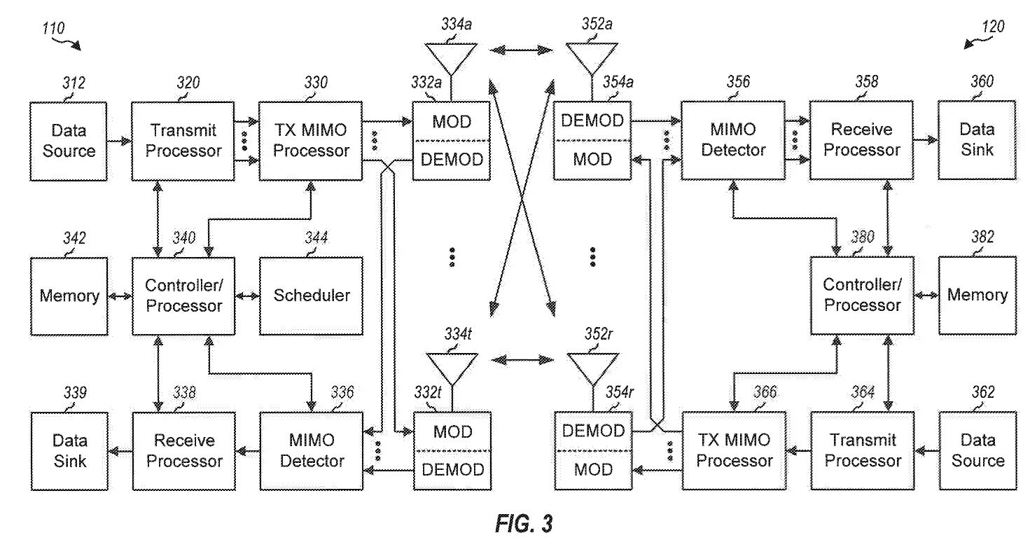

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t (referred to collectively as antenna(s) 334), and the UE 120 may be equipped with antennas 352a through 352r (referred to collectively as antenna(s) 352).

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODS) 332a through 332t (referred to collectively as modulator(s) 332). Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively (referred to collectively as demodulator(s) 354). Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MEMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc,), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

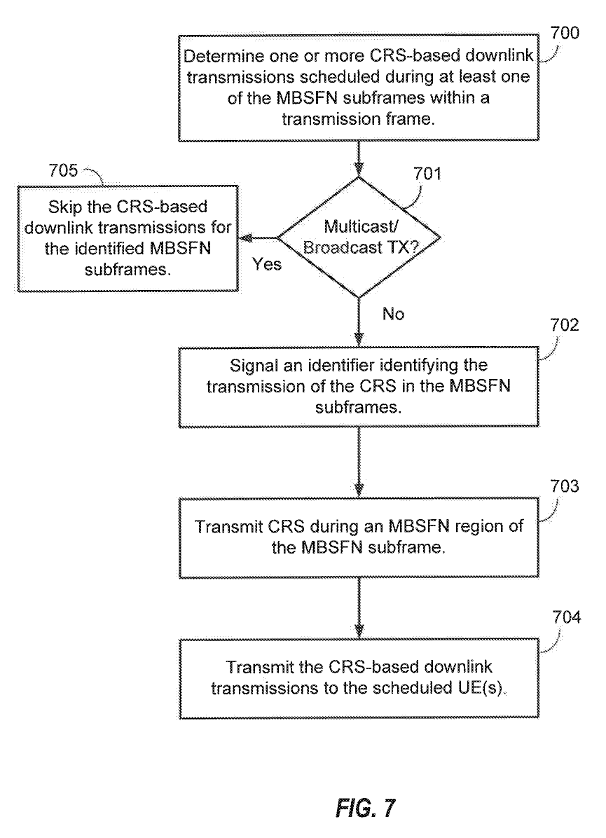

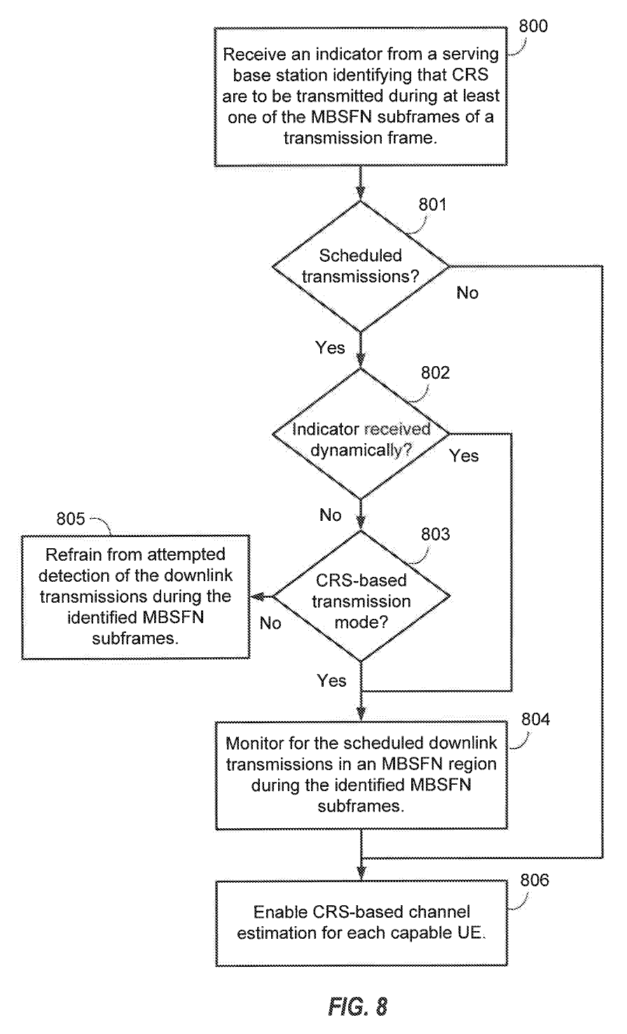

The controllers/processors 340 and 380 may direct the operation at the base station 110 and the UE 120, respectively. The processor 340 and/or other processors and modules at the base station 110 may perform or direct the execution of various processes for the techniques described herein, for example, the process described with reference to FIG. 7. The processor 380 and/or other processors and modules at the UE 120 may also perform or direct the execution of the functional blocks illustrated in FIGS. 7 and 8, and/or other processes for the techniques described herein, for example, the process described with reference to FIG. 8. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for performing blocks 800, 801, 802, 803, 804, 805, and 806 with reference to FIG. 8. In one aspect, the aforementioned means may be the processor(s), the controller/processor 380, the memory 382, the receive processor 358, the MIMO detector 356, the demodulators 354, and the antennas 352 configured to perform the functions recited by the aforementioned means. In another aspect, the aforementioned means may be a module or any apparatus configured to perform the functions recited by the aforementioned means. In one configuration, the base station 110 for wireless communication includes means for performing blocks 700, 701, 702, 703, 704, and 705 with reference to FIG. 7. In one aspect, the aforementioned means may be the processor(s), the controller/processor 340, the memory 342, the transmit processor 320, the TX MIMO processor 330, the modulator(s) 332, and the antenna(s) 334 configured to perform the functions recited by the aforementioned means. In another aspect, the aforementioned means may be a module or any apparatus configured to perform the functions recited by the aforementioned means.

eMBMS AND UNICAST SIGNALING IN SINGLE FREQUENCY NETWORKS: One technique to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), can utilize such SFN operation. SFNs utilize radio transmitters, such as, for example, eNBs, to communicate with subscriber UEs. Groups of eNBs can transmit information in a synchronized manner, so that signals reinforce one another rather than interfere with each other. In the context of eMBMS, the shared content is transmitted from multiple eNB's of a LTE network to multiple UEs. Therefore, within a given eMBMS area, a UE may receive eMBMS signals from any eNB(s) within radio range as part of the eMBMS service area or MBSFN area. However, to decode the eMBMS signal each UE receives Multicast Control Channel (MCCH) information from a serving eNB over a non-eMBMS channel. MCCH information changes from time to time and notification of changes is provided through another non-eMBMS channel, the PDCCH. Therefore, to decode eMBMS signals within a particular eMBMS area, each UE is served MCCH and PDCCH signals by one of the eNBs in the area.

In accordance with aspects of the subject of this disclosure, there is provided a wireless network (e.g., a 3GPP network) having features relating to single carrier for eMBMS. eMBMS provides an efficient way to transmit shared content from an LTE network to multiple mobile entities, such as, for example, UEs.

With respect a physical layer (PHY) of eMBMS for LTE Frequency Division Duplex (FDD), the channel structure may comprise time division multiplexing (TDM) resource partitioning between eMBMS and unicast transmissions on mixed carriers, thereby allowing flexible and dynamic spectrum utilization. Currently, a subset of subframes (up to 60%), known as multimedia broadcast single frequency network (MBSFN) subframes, can be reserved for eMBMS transmission. As such current eMBMS design allows at most six out of ten subframes for eMBMS.

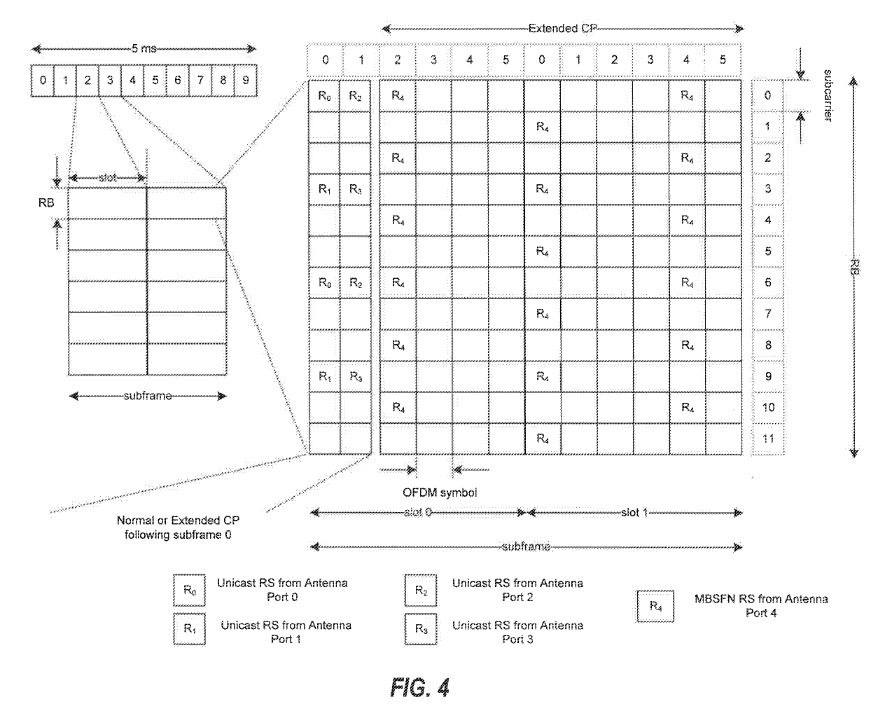

An example of subframe allocation for eMBMS is shown in FIG. 4, which shows an existing allocation of MBSFN reference signals on MBSFN subframes, for a single-carrier case. Components depicted in FIG. 4 correspond to those shown in FIG. 2, with FIG. 4 showing the individual subcarriers within each slot and resource block (RB). In 3GPP LTE, an RB spans 12 subcarriers over a slot duration of 0.5 ms, with each subcarrier having a bandwidth of 15 kHz together spanning 180 kHz per RB. Subframes may be allocated for unicast or eMBMS; for example in a sequence of subframes labeled 0, 1, 2, 3, 4, 5, 6, 7, 8, and 9, subframes 0, 4, 5, and 9 may be excluded from eMBMS in FDD. Also, subframes 0, 1, 5, and 6 may be excluded from eMBMS in time division duplex (TDD). More specifically, subframes 0, 4, 5, and 9 may be used for PSS/SSS/PBCH/paging/system information blocks (SIBs) and unicast service. Remaining subframes in the sequence, e.g., subframes 1, 2, 3, 6, 7, and 8 may be configured as eMBMS subframes.

With continued reference to FIG. 4, within each eMBMS subframe, the first 1 or 2 symbols may be used for unicast reference symbols (RSs) and control signaling, A CP length of the first 1 or 2 symbols may follow that of subframe 0. A transmission gap may occur between the first 1 or 2 symbols and the eMBMS symbols if the CP lengths are different. Known techniques for providing MBSFN RSs and unicast RSs typically involve allocating the MBSFN RSs on MBSFN subframes (as shown in FIG. 4), and separately allocating unicast RSs on non-MBSFN subframes. More specifically, as FIG. 4 shows, the extended CP of the MBSFN subframe includes MBSFN RSs but not unicast RSs. The present technology is not limited to the particular frame allocation scheme illustrated by FIGS. 2 and 4, which are presented by way of example, and not by way of limitation. A multicast session or multicast broadcast as used herein may use any suitable frame allocation scheme.

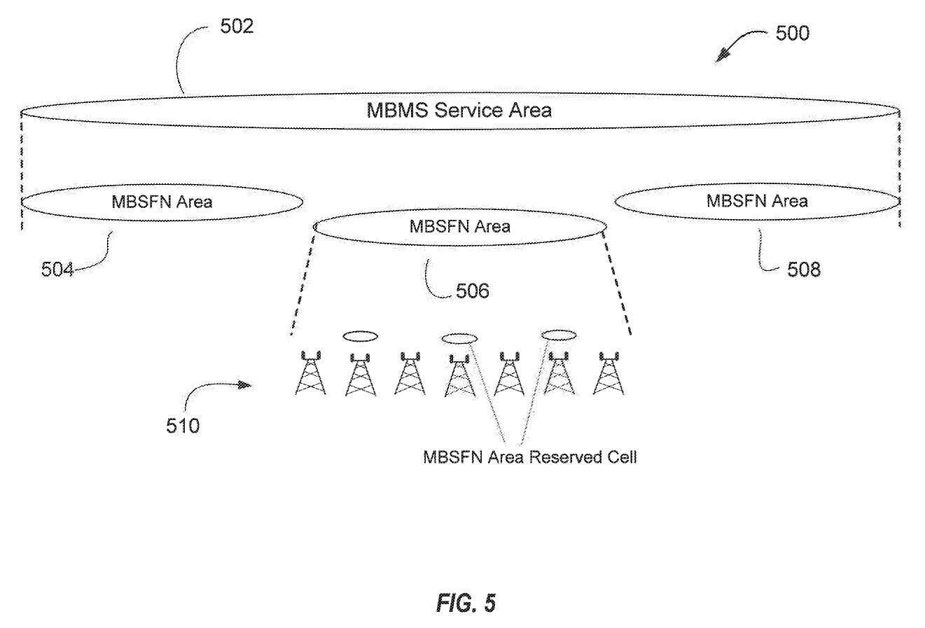

eMBMS SERVICE AREAS: FIG. 5 illustrates a system 500 including an MBMS service area 502 encompassing multiple MBSFN areas 504, 506, 508, which themselves include multiple cells or base stations 510. As used herein, an “MBMS service area” refers to a group of wireless transmission cells where a certain MBMS service is available. For example, a particular sports or other program may be broadcast by base stations within the MBMS service area at a particular time. The area where the particular program is broadcast defines the MBMS service area. The MBMS service area may be made up of one or more “MBSFN areas” as shown at 504, 506 and 508. As used herein, an MBSFN area refers to a group of cells (e.g., cells 510) currently broadcasting a particular program in a synchronized fashion using an MBSFN protocol. An “MBSFN synchronization area” refers to a group of cells that are interconnected and configured in a way such that they are capable of operating in a synchronized fashion to broadcast a particular program using an MBSFN protocol, regardless of whether or not they are currently doing so. Each eNB can belong to only one MBSFN synchronization area, on a given frequency layer. It is worth noting that an MBMS service area 502 may include one or more MBSFN synchronization areas (not shown). Conversely, an MBSFN synchronization area may include one or more MBSFN areas or MBMS service areas. Generally, an MBSFN area is made up of all, or a portion of, a single MBSFN synchronization area and is located within a single MBMS service area. Overlap between various MBSFN areas is supported, and a single eNB may belong to several different MBSFN areas. For example, up to 8 independent MCCHs may be configured in System Information Block (SIB) 13 to support membership in different MBSFN areas. An MBSFN Area Reserved Cell or Base Station is a cell/base station within a MBSFN Area that does not contribute to the MBSFN transmission, for example a cell near a MBSFN Synchronization Area boundary, or a cell that that is not needed for MBSFN transmission because of its location.

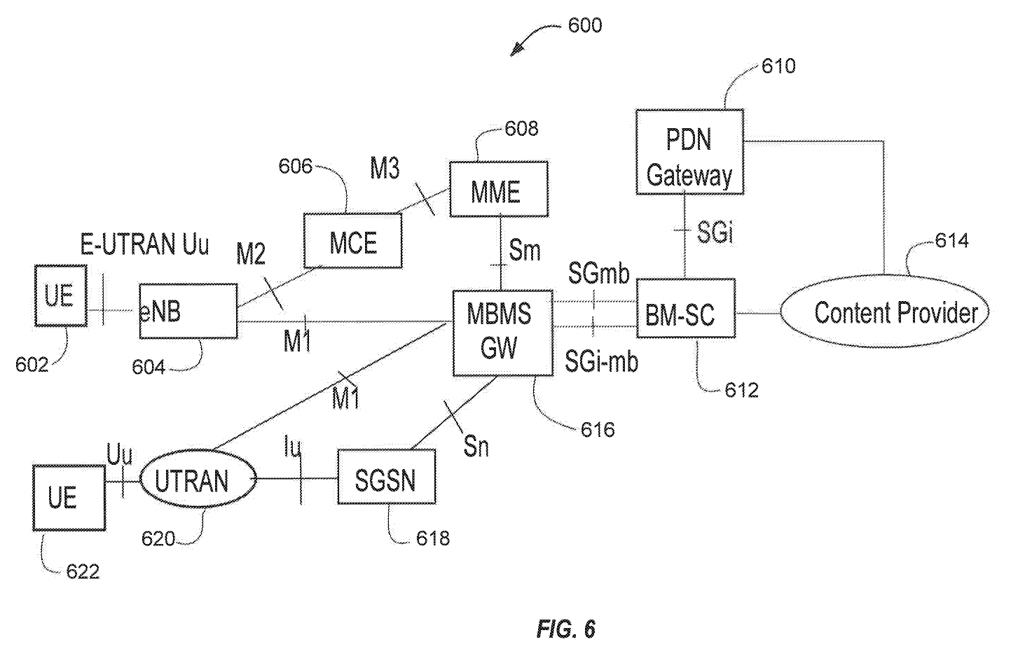

eMBMS SYSTEM COMPONENTS AND FUNCTIONS: FIG. 6 illustrates functional entities of a wireless communication system 600 for providing or supporting MBSFN service. Regarding Quality of Service (QoS), the system 600 may use a Guaranteed Bit Rate (GBR) type MBMS bearer, wherein the Maximum Bit Rate (MBR) equals the GBR. These components are shown and described by way of example, and do not limit the inventive concepts described herein, which may be adopted to other architectures and functional distributions for delivering and controlling multicast transmissions.

The system 600 may include an MBMS Gate Way (MBMS GW) 616. The MBMS GW 616 controls Internet Protocol (IP) multicast distribution of MBMS user plane data to eNodeBs 604 via an M1 interface; one eNB 604 of many possible eNBs is shown. In addition, the MBMS GW controls IP multicast distribution of MBMS user plane data to Universal or UMTS Terrestrial Radio Access Network (UTRAN) Radio Network Controllers (RNCs) 620 via an M1 interface; one UTRAN RNC 620 of many possible RNCs is shown. The M1 interface is associated to MBMS data (user plane) and makes use of IP for delivery of data packets. The eNB 604 may provide MBMS content to a user equipment (UE)/mobile entity 602 via an E-UTRAN Uu interface. The RNC 620 may provide MBMS content to a UE mobile entity 622 via a Uu interface. The MBMS GW 616 may further perform MBMS Session Control Signaling, for example MBMS session start and session stop, via the Mobility Management Entity (MME) 608 and Sm interface. The MBMS GW 616 may further provide an interface for entities using MBMS bearers through the SG-mb (user plane) reference point, and provide an interface for entities using MBMS bearers through the SGi-mb (control plane) reference point. The SG-mb Interface carries MBMS bearer service specific signaling. The SGi-mb interface is a user plane interface for MBMS data delivery. MBMS data delivery may be performed by IP unicast transmission, which may be a default mode, or by IP multicasting. The MBMS GW 616 may provide a control plane function for MBMS over UTRAN via a Serving General Packet Radio Service Support Node (SGSN) 618 and the Sn/Iu interfaces.

The system 600 may further include a Multicast Coordinating Entity (MCE) 606. The MCE 606 may perform an admission control function form MBMS content, and allocate time and frequency radio resources used by all eNBs in the MBSFN area for multi-cell MBMS transmissions using MBSFN operation. The MCE 606 may determine a radio configuration for an MBSFN Area, such as, for example, the modulation and coding scheme. The MCE 606 may schedule and control user plane transmission of MBMS content, and manage eMBMS service multiplexing, by determining which services are to be multiplexed in which Multicast Channel (MCH). The MCE 606 may participate in MBMS Session Control Signaling with the MME 608 through an M3 interface, and may provide a control plane interface M2 with the eNB 604.

The system 600 may further include a Broadcast-Multicast Service Center (BM-SC) 612 in communication with a content provider server 614. The BM-SC 612 may handle intake of multicast content from one or more sources such as the content provider 614, and provide other higher-level management functions as described below. These functions may include, for example, a membership function, including authorization and initiation of MBMS services for an identified UE. The BM-SC 612 may further perform MBMS session and transmission functions, scheduling of live broadcasts, and delivery, including MBMS and associated delivery functions. The BM-SC 612 may further provide service advertisement and description, such as advertising content available for multicast. A separate Packet Data Protocol (PDP) context may be used to carry control messages between the UE and the BM-SC. The BM-SC may further provide security functions such as key management, manage charging of content providers according to parameters such as data volume and QoS, provide content synchronization for MBMS in UTRAN and in E-UTRAN for broadcast mode, and provide header compression for MBSFN data in UTRAN. The BM-SC 612 may indicate session start, session update and session stop to the MBMS-GW 616 including session attributes such as QoS and MBMS service area.

The system 600 may further include a Multicast Management Entity (MME) 608 in communication with the MCE 606 and MBMS-GW 608. The MME 608 may provide a control plane function for MBMS over E-UTRAN. In addition, the MME may provide the eNB 604, 620 with multicast related information defined by the MBMS-GW 616. An Sm interface between the MME 608 and the MBMS-GW 616 may be used to carry MBMS control signaling, for example, session start and session stop signals.

The system 600 may further include a Packet Data Network (PDN) Gate Way (GW) 610, sometimes abbreviated as a P-GW, The P-GW 610 may provide an Evolved Packet System (EPS) bearer between the UE 602 and BM-SC 612 for signaling and/or user data. As such, the P-GW may receive Uniform Resource Locator (URL) based requests originating from UEs in association with IP addresses assigned to the UEs. The BM-SC 612 may also be linked to one or more content providers via the P-GW 610, which may communicate with the BM-SC 612 via an IP interface.

In LIE networks, multicast-broadcast functionality has been accommodated through configuration of multicast-broadcast single frequency network (MBSFN) subframes within the transmission frame. These MBSFN subframes can handle transmissions of MBMS-type transmission services (e.g., MBMS, enhanced MBMS (eMBMS), further enhanced MBMS (FeMBMS), etc.). In regions where such multicast-broadcast services are present, between 60% (eMBMS) and 80% (FeMBMS) of the scheduled downlink subframes may be reserved or configured for such multicast-broadcast services. Each such configured MBSFN subframe includes, a non-MBSFN region, which may occupy the first one or two OFDM symbol(s). CRS signals and various control channel signaling may be present in the non-MBSFN region of MBSFN subframes. MBSFN subframes also include an MBSFN region of the MBSFN subframe, which incorporates the remaining portion of the transmission time interval (TTI) of the MBSFN subframe excluding the non-MBSFN region. CRS is not currently transmitted in the MBSFN region of a MBSFN subframe. Instead, when actual multicast-broadcast transmissions are scheduled, MBSFN reference signals (MBSFN RS) are transmitted.

The MBSFN region of the MBSFN sub-frame can be used to convey unicast data transmissions (e.g., PDSCH) when there are no multicast-broadcast transmissions present. However, because there are no CRS within the MBSFN region, currently, only non-CRS-based transmissions may be accommodated. For example, current transmission mode 9 or 10 (TM9/10) UEs may be scheduled for data transmissions within an MBSFN region, as TM9/10 UE transmissions may be decoded based on demodulation reference signals (DMRS). Therefore, TM9/10 unicast data transmission in MBSFN subframe may generally enjoy zero CRS overhead from the serving cell, as well as less CRS interference from neighbor cells.

In various aspects of the present disclosure, the network can schedule unicast data transmissions for non-TM9/10 UEs (UEs having a CRS-based transmission mode) by selectively transmitting CRS within the MBSFN region of the MBSFN subframe based on data transmission scheduling for the CRS-based transmission mode UEs. In order to implement such CRS transmissions within the MBSFN region, there should be no multicast-broadcast transmissions scheduled for the MBSFN subframe, and there should be at least one CRS-based transmission mode UE with unicast data transmissions scheduled in the same MBSFN subframe. This may help to minimize CRS interference across cells in the MBSFN subframes.

FIG. 7 is a block diagram illustrating example blocks executed to implement one aspect of the present disclosure. At block 700, a base station determines one or more CRS-based downlink transmissions scheduled during at least one of the MBSFN subframes within a transmission frame. Without any CRS-based downlink transmissions, there is no need for the base station to enable the described aspect. Thus, having CRS-based transmissions scheduled for the identified MBSFN subframe begins the disclosed aspect.

At block 701, a determination is made by the base station whether there is any multicast-broadcast transmissions scheduled in the MBSFN subframe. Because the various aspects of the present disclosure may be used only when no multicast-broadcast transmissions are scheduled for the MBSFN subframes, the base station should determine the multicast-broadcast transmission scheduling first. If such transmissions are currently scheduled for the MBSFN subframe, then, at block 705, the base station skips the CRS-based downlink transmissions for the identified MBSFN subframes.

At optional block 702, however, if no multicast-broadcast transmissions are scheduled, then the base station signals an identifier identifying the transmission of the CRS in the identified MBSFN subframe. Prior to transmitting CRS and CRS-based unicast data in the MBSFN subframe, the base station will transmit signaling that identifies that such CRS and CRS-based transmissions will be transmitted. The signaling may be provided semi-statically or dynamically, such as through a system information message or downlink control information (DCI). When dynamically signaled, the signaling may be transmitted in the non-MBSFN region of the MBSFN subframe where CRS and CRS-based unicast data is transmitted or transmitted at least one location (such as one subframe or one slot or one symbol) before the actual MBSFN subframe where CRS and CRS-based unicast data is transmitted.

CRS transmissions in the MBSFN region may be wideband, such as across the entire system bandwidth, or may be transmitted across a portion of the system bandwidth or limited to a subset of resource blocks (RBs) that include the RBs allocated to the CRS-based unicast data transmission. The subset of RBs may include one or more RBs on which the one or more CRS-based downlink transmissions are transmitted. For non-wideband CRS transmission, the CRS may be present in the RBs specifically allocated for the data transmission, but may also be transmitted in additional RBs at the edges (for example, at both edges of the subset of RBs) in order to remove edge effect.

It should be noted that in cases where the RBs allocated for the data transmissions are distributed and not, themselves contiguous, the CRS may be transmitted in a contiguous set of RBs that incorporate all the non-contiguous RBs allocated for the unicast data transmissions in order to allow for discrete Fourier transformation (DFT)-based processing. Thus, the resulting CRS are present from the lowest RB carrying unicast data to the highest RB carrying unicast data. Where the alternative aspect that includes additional RBs at the edges is implemented, the CRS would be further present in the additional edge RBs as well.

When wideband CRS transmission is used in the MBSFN region, no non-CRS-based transmissions should be present in the same MBSFN subframe for a legacy UE that does not know CRS may be transmitted in the MBSFN region of the MBSFN subframe. This ensures that no rate matching issues arise for legacy UEs configured in a non-CRS-based transmission mode (e.g.,TM9/10 UEs) that is not aware of the CRS presence in the MBSFN region. When a base station determines that non-CRS-based transmissions may be scheduled within the MBSFN region in the presence of legacy UEs, it may prohibit selection of the transmission of CRS across the system bandwidth. If CRS are transmitted across the system bandwidth, the base station may schedule any legacy UEs or UEs in a non-CRS-based transmission mode by rate matching unicast data transmissions around the CRS transmissions in the MBSFN subframe. MBSFN subframes used for legacy TM9/10 UEs and non-TM9/10 UEs may be strictly disjointed in order to avoid such issues. The base station may further signal, either semi-statically or dynamically via DCI, whether CRS-based transmission will be across the entire system bandwidth (wideband) or RB-selective (partial band).

Returning to block 701, in response to a determination of no multicast-broadcast transmissions in the MBSFN subframe, block 702 may optionally be performed followed by blocks 703 and 704, or blocks 703 and 704 may be performed after block 701 without performing block 702. At block 703, the base station transmits CRS during iii MBSFN region of the identified MBSFN subframe. The base station will transmit CRS during the MBSFN region of the identified MBSFN subframe according to typical CRS procedures. Therefore, UEs expecting now to detect the CRS will have an idea of the CRS locations within the subframe.

At block 704, the base station transmits the CRS-based downlink transmissions to the scheduled UEs. The base station sends the data transmissions to the scheduled CRS-based transmission mode UEs, which may then be able to use the CRS to properly decode the transmitted data.

FIG. 8 is a block diagram illustrating example blocks executed to implement one aspect of the present disclosure. At block 800, a UE receives an indicator from a serving base station identifying that CRS are to be transmitted in a MBSFN region during one or more MBSFN subframes of a transmission frame. The indicator can identify that the CRS are transmitted either across a system bandwidth or across a portion of the system bandwidth.

At block 801, a determination is made by the UE whether it has any scheduled downlink transmissions during the MBSFN subframes. When CRS is transmitted in an MBSFN subframe, the base station can announce only to those UEs that are scheduled for transmission (such as in the UE-specific search space) or may announce to all UEs, including those that are not scheduled for data transmissions (such as through a DCI in the common search space). The DCI can additionally identify what RBs will used for transmission of CRS. As noted with regard to block 806, this information can be exploited by all capable UEs to keep running channel estimation loops or FTL/TTL.

If the UE determines that it has been scheduled for data transmissions during the MBSFN subframes, then a further determination, at block 802, concerns how the indicator was received. If it was received semi-statically, then the UE would have the indication of CRS-based transmissions in the MBSFN subframes in advance of those subframes. If the indicator is received dynamically, such as via DCI, then the UE may not know too far in advance of the MBSFN subframe if CRS-based transmissions will be present. UE may monitor at least one of the control channel transmitted in the non-MBSFN region of a MBSFN subframe and the control channel transmitted at least one subframe or slot or OFDM symbol ahead of a MBSFN subframe to determine whether the CRS transmission in the MBSFN region will happen in the MBSFN subframe. A subset of MBSFN subframes that are available for non-TM9/10 unicast data transmission can be signaled semi-statistically or dynamically implied by DCI. As noted above, when semi-statistically signaled, the UE does not have to monitor for unicast data grants on the MBSFN subframes that do not match its configured transmission mode except for a new, non-CRS-based TM9/10 UE that supports the unicast data rate-matching around CRS or supports CRS-based fallback transmission mode in the MBSFN subframes. When dynamically signaled through DCI, for example, both TM9/10 (non-CRS-based transmission mode) and non-TM9/10 (CRS-based transmission mode) UEs are expected to monitor for unicast data transmission grants for their respective relevant DCI format in every MBSFN subframe.

If the indicator is not received dynamically and, instead received semi-statically, then at block 803, a determination is made whether the UE is in a CRS-based transmission mode or a non-CRS-based transmission mode. If the UE is in a non-CRS-based transmission mode and does not support the rate-matching of its unicast data around CRS and does not support the CRS-based fallback transmission modes in the MBSFN subframe, then, at block 805, the UE may refrain from attempting to detect any downlink transmissions during the identified MBSFN subframes.

If, however, the UE is in a CRS-based transmission mode, then, at block 804, the UE monitors for the scheduled downlink transmissions in a multicast-broadcast single frequency network (MBSFN) region during the identified MBSFN subframes. Moreover, when the indicator has been received dynamically, as determined at block 802, then the UE will also monitor for the scheduled downlink transmission regardless of whether it is in a CRS-based transmission mode or not.

At block 806, the UE enables CRS-based channel estimation when it is capable of performing such process. The UE may be capable either when it is configured in a CRS-based transmission mode or if it is currently in a non-CRS-based transmission mode but receives, for example, a CRS-based downlink grant that includes a CRS-based fallback transmission mode, or a CRS-based downlink grant that indicates that the unicast transmission is rate-matched around the CRS in the MBSFN subframe. In such case, the non-CRS-based UE will fall back to a CRS-based mode for the data transmissions in the identified MBSFN subframes. Additionally, when the UE are determined not to have any scheduled transmissions in the MBSFN region of the identified MBSFN subframes at block 801, such UEs may also perform CRS-based channel estimation.

The UE may enable or disable CRS-based channel estimation depending on the unicast data scheduling and/or the identification of whether the CRS-transmissions will be wideband or partial band.

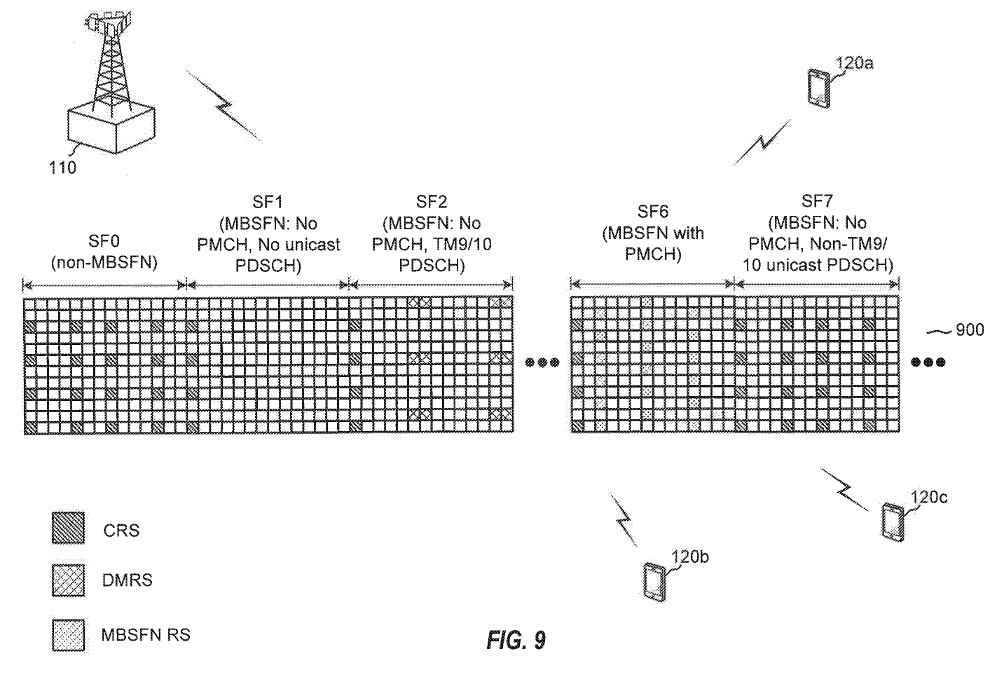

FIG. 9 is a block diagram illustrating base station 110 and UEs 120a-c configured according to one aspect of the present disclosure. Communications between base station 110 and UEs 120a-c occur via radio frame 900. For convenience, FIG. 9 illustrated only five of the ten subframes contained within radio frame 900. Within radio frame 900, six of the ten subframes are configured as MBSFN subframes (subframe (SF) 1, SF 2, SF 3 (not shown), SF 6, SF 7, and SF 8 (not shown)). In an example of the non-MBSFN subframes, SF 0 is illustrated having CRS transmitted in the standard resource elements (REs). In MBSFN subframes, the first one or two symbols are the non-MBSFN region. CRS may be present, as illustrated in SF 1, SF 2, and SF 6, in the non-MBSFN region, while the MBSFN region are used for other purposes. For example, at SF 1, the MBSFN region is empty with no multicast-broadcast transmissions or unicast data transmissions. At SF 2, no multicast-broadcast transmissions are present, but unicast data transmissions are made to TM9/10 UEs, UEs 120b and 120c. DMRS are illustrated as transmitted during SF 2 which allows the DMRS-based transmissions of the unicast data to UEs 120b and 120c. At SF 6, after the CRS in the non-MBSFN region, the MBSFN region are used for multicast-broadcast transmissions. MBSFN reference signals (RS) are transmitted in the MBSFN region of SF 6 along with the multicast-broadcast transmissions.

The operations at SF 7 occur according to the example aspect of the present disclosure. SF 7 is an MBSFN subframe. However, there are no multicast-broadcast transmissions scheduled during SF 7 and at least one CRS-based transmission mode UE, UE 120a, is scheduled for unicast data transmission. Accordingly, base station 110 transmits CRS not only in the non-MBSFN region of SF 7, but also in the MBSFN region. Base station 110 may then transmit the unicast data transmissions to UE 120a in the available REs in the MBSFN region of SE 7. Additionally, UE 120a and other UEs, which may not necessarily be scheduled for CRS-based transmissions in SF 7, may use the CRS for channel estimation.

The network may allocate or assign MBSFN subframes for potential unicast data transmissions to UEs being served by the particular base station. In some scenarios, there may be a common allocation where CRS-based and non-CRS-based transmission mode UEs may be allocated to the same MBSFN subframes. The network may also use disjoint allocation by allocating different MBSFN subframes to CRS-based transmission mode UEs and non-CRS-based transmission mode UEs. In such a disjoint allocation scenario, a first subset of the plurality of MBSFN subframes are allocated for transmission with the one or more UEs in the CRS-based transmission mode and a second subset of the plurality of MBSFN subframes are assigned for transmissions with one or more additional UEs in a non-CRS-based transmission mode. When such a disjointed allocation of MBSFN subframes is used, the network may allocate a number of MBSFN subframes to non-CRS-based transmission mode UEs (e.g., TM9/10 UEs) and CRS-based transmission mode UEs (e.g., non-TM9/10 UEs) depending on the UE distribution.

For example, within the subframes of radio frame 900, SF 1, SF 2, SF 3 (not shown), SF 6, SF 7, and SF 8 (not shown) are the MBSFN subframes. The network may distribute the allocation of these MBSFN subframes according to the distribution of the types of UEs. If there were three CRS-based transmission mode UEs and three non-CRS-based transmission mode UEs, the network may allocate {1,2,3} to the CRS-based UEs, and {6,7,8} to the non-CRS-based UEs. If there were two CRS-based UEs and four non-CRS-based UEs, the network may modify the allocation so that {1,2} are allocated to the CRS-based UEs, while {3,6,7,8} are allocated to the non-CRS-based UEs.

When the network uses common allocation of MBSFN subframes for different UEs. The treatment of unicast data transmission scheduling for the different UE types may depend on Whether the CRS is transmitted in a wideband fashion across the entire system bandwidth or across a partial band. When base station 110 transmits wideband CRS for the CRS-based transmission mode UEs, the network may either (1) explicitly not schedule (or refrain from scheduling) unicast transmissions for any non-CRS-based transmission mode UEs or (2) schedule a fallback CRS-based transmission mode for the non-CRS-based UEs. When a non-CRS-based UE receives the downlink grant for data transmissions in the MBSFN region during the one or more MBSFN subframes, the downlink grant may include a trigger for the CRS-based fallback mode. The non-CRS-based UE will change, in response to the trigger, to a CRS-based transmission mode for that scheduled MBSFN subframe in order to monitor for and decode any unicast data transmissions. When base station 110 transmits CRS on a partial band basis or on selective RBs used for CRS-based unicast data transmissions, the CRS-based and non-CRS-based UEs may both be served in the same MBSFN subframe by using frequency division multiplex (FDM) to transmit on a disjoint set of RBs of the subframe.

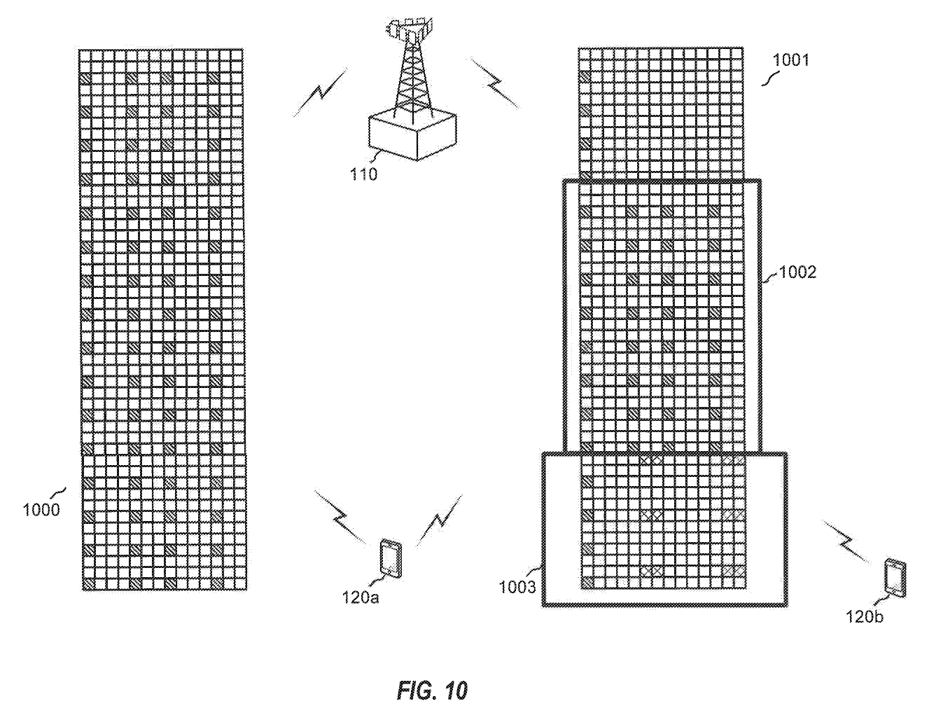

FIG. 10 is a block diagram illustrating a base station 110 and UEs 120a and 120b configured according to one aspect of the present disclosure. Base station 110 transmits CRS in the MBSFN subframe 1000 using the entire system bandwidth. With this wideband CRS transmission, base station 110 only is able to schedule the CRS-based unicast transmission in MBSFN subframe 1000 to CRS-based transmission mode UE 120a. At MBSFN subframe 1001, base station 110 transmits CRS using only the selected RBs allocated for CRS-based unicast data transmission to UE 120a. The selected RBs for the CRS-based unicast transmission are located within region 1002 of MBSFN subframe 1001. Base station 110 may, therefore, also schedule non-CRS-based unicast data transmission to non-CRS-based UEs (e.g., UE 120b) by scheduling the transmissions in region 1003 of MBSFN subframe 1001. Base station 110 may signal both that it intends to transmit CRS within the MBSFN region of MBSFN subframes 1000 and 1001 through signaling to UEs 120a and 120b. This signaling may be transmitted on a semi-static basis or dynamically, such as through a DCI. The identification of whether the CRS will be wideband or selective RB/partial band may also be signaled to UEs 120a and 120b either semi-statically or dynamically.

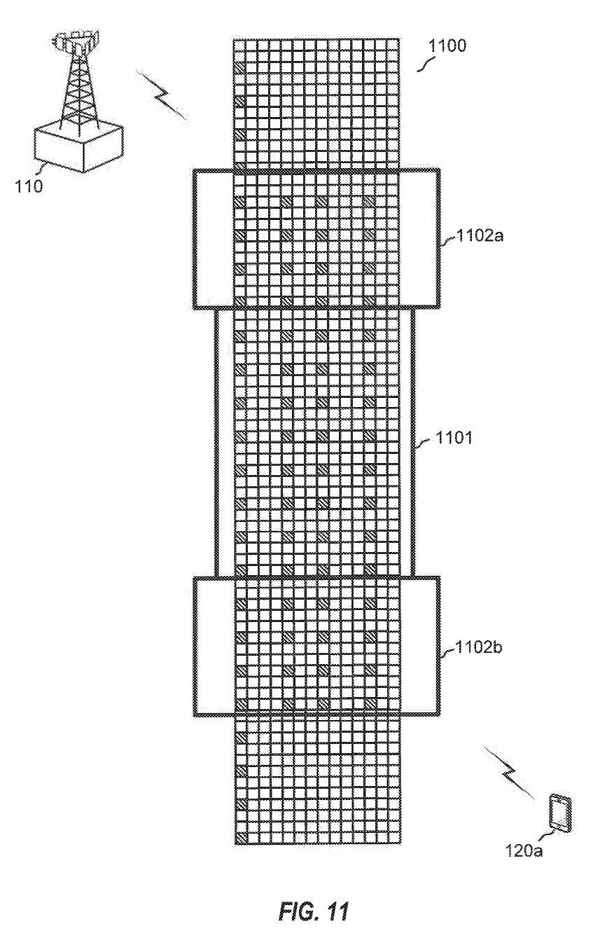

FIG. 11 is a block diagram illustrating a base station 110 and a UE 120a configured according to one aspect of the present disclosure. As previously indicated, when base station 110 determines to transmit CRS in MBSFN subframe 1100 using the selective RB or partial band means for CRS-based UEs, such as UE 120a, it would transmit CRS in the selected RBs of region 1101 that are allocated for the CRS-based unicast transmission as well as in edge areas 1102a and 1102b. The unicast data is not transmitted in the available REs in edge areas 1102a and 1102b. However, UE 120a and other CRS-based transmission mode UEs may use the CRS transmitted in region 1101, and edge areas 1102a, and 1102b, for CRS-based channel estimation. The transmission of the CRS in edge areas improves the channel estimation by reducing the edge effect.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the functional blocks and modules in FIGS. 7 and 8 may comprise processors, electronics devices, hardware devices, electronics components, logical circuits, memories, software codes, firmware codes, etc., or any combination thereof. To illustrate this interchangeability of hardware and software, various illustrative components, blocks, modules, circuits, and steps have been described above generally in terms of their functionality, Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the disclosure herein may be embodied directly in hardware, in a software module executed by a processor, or in a combination of the two. A software module may reside in RAM memory, flash memory, read-only memory (ROM) memory, erasable programmable read-only memory (EPROM) memory, electrically erasable programmable read-only memory (EEPROM) memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A computer-readable storage medium may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, non-transitory connections may properly be included within the definition of computer-readable medium. For example, if the instructions are transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining, by a base station, one or more cell-specific reference signal (CRS)-based downlink transmissions scheduled during a multicast-broadcast single frequency network (MBSFN) subframe of a plurality of MBSFN subframes within a transmission frame for one or more user equipments (Us), wherein the one or more UEs are configured for a CRS-based transmission mode; and
in response to determination of no multicast-broadcast transmissions in the MBSFN subframe:
transmitting, by the base station, CRS during a MBSFN region of the MBSFN subframe; and
transmitting, by the base station, the one or more CRS-based downlink transmissions to the one or more UEs.

2. The method of claim 1, further including:
signaling, by the base station, an identifier identifying the transmitting of the CRS, wherein the transmitting the CRS includes one of:
transmitting the CRS across a system bandwidth; or
transmitting the CRS across one or more resource blocks (RBs) on which the one or more CRS-based downlink transmissions are transmitted.

3. The method of claim 2, wherein the transmitting the CRS across the one or more RBs further includes:
transmitting the CRS across one or more additional RBs at both edges of the one or more RBs.

4. The method of claim 2, wherein the transmitting the CRS across one or more RBs includes:
transmitting the CRS across a contiguous set of RBs that incorporates the one or more RBs when the one or more RBs are non-contiguous, wherein the contiguous set of RBs spans a lowest RB on which at least a portion of the one or more CRS-based downlink transmissions is transmitted and a highest RB on which at least another portion of the one or more CRS-based downlink transmissions is transmitted.

5. The method of claim 2, wherein the signaling signals the identifier to one of:
all UEs served by the base station; or
selected UEs with the downlink transmissions scheduled in the MBSFN subframe where the CRS is transmitted.

6. The method of claim 2, wherein the signaling identifies the identifier using:
system information message; or
downlink control information (DCI) in a control channel transmitted in the MBSFN subframe where CRS is transmitted; or
the DCI in the control channel transmitted in a location including one of:
a subframe, or
a slot, or
an OFDM symbol,
at least one location before the MBSFN subframe where CRS is transmitted.

7. The method of claim 2, wherein one of:
a first subset of the plurality of MBSFN subframes are allocated for transmissions with the one or more UEs in the CRS-based transmission mode and a second subset of the plurality of MBSFN subframes are assigned for transmissions with one or more additional UEs in a non-CRS-based transmission mode; or
the plurality of MBSFN subframes are configured for use for transmissions with any UE served by the base station.

8. The method of claim 7, further including:
allocating a number of MBSFN subframes in one of the first subset or the second subset depending on a UE distribution.

9. The method of claim 7, further including:
determining, by the base station, one or more non-CRS-based scheduled transmissions within the MBSFN subframe to one or more additional UEs, wherein the one or more additional UEs are configured for non-CRS-based transmissions;
prohibiting, by the base station, selection of the transmitting the CRS across the system bandwidth in response to the determining the one or more non-CRS-based scheduled transmissions; and
in response to the transmitting the CRS across the system bandwidth, one of:
refraining, by the base station, from scheduling transmissions to the one or more additional UEs in a non-CRS-based transmission mode; or
scheduling, by the base station, the one or more additional UEs in the non-CRS-based transmission mode by rate-matching unicast data transmissions to the one or more additional UEs around the CRS transmissions in the MBSFN subframe; or
scheduling, by the base station, a fallback transmission mode for the one or more additional UEs, wherein the fallback transmission mode configured the one or more additional UEs for the CRS-based transmission mode.

10. The method of claim 7, further including, in response to the transmitting the CRS across the one or more RBs on which the one or more CRS-based downlink transmissions are transmitted:
transmitting, by the base station, downlink transmission to one or more additional UEs in a non-CRS-based transmission mode using one or more additional RBs of the system bandwidth, wherein the one or more RBs are disjoint with respect to the one or more additional RBs.

11. The method of claim 1, further including:
determining, by the base station, a subset of MBSFN subframes of the plurality of MBSFN subframes of the transmission frame available for CRS-based transmissions; and
signaling, by the base station, an indicator to all UEs served by the base station, wherein the indicator indicates the subset of MBSFN subframes.

12. A method of wireless communications, comprising:
receiving, by a user equipment (UE), an indicator from a serving base station, wherein the indicator identifies that cell-specific reference signals (CRS) are to be transmitted in a multicast-broadcast single frequency network (MBSFN) region during one or more MBSFN subframe of a transmission frame either across a system bandwidth or across a portion of the system bandwidth;
in response to the indicator being received semi-statically, one of:
monitoring, by the UE, in response to the UE being configured in a CRS-based transmission mode, for downlink transmissions scheduled in the MBSFN region during the one or more MBSFN subframes; or
refraining, by the UE, in response to the UE being configured in a non-CRS-based transmission mode, from attempted detection of the downlink transmissions during the one or more MBSFN subframes; or
monitoring, by the UE, in response to the UE being configured in a non-CRS-based transmission mode, for the downlink transmissions scheduled in the MBSFN region during the one or more MBSFN subframes based on one of: the CRS-based fallback transmission mode or the non-CRS-based transmission mode with rate-matching around the CRS; and
in response to the indicator being received dynamically,
monitoring, by the UE, for the downlink transmissions scheduled in the MBSFN region during the one or more MBSFN subframes.

13. The method of claim 12, further including:
receiving, by the UE, a CRS-based downlink grant for at least one MBSFN subframe of the one or more MBSFN subframes; and
enabling, by the UE, CRS-based channel estimation in the at least one MBSFN subframe.

14. The method of claim 13, wherein the CRS-based channel estimation is performed over one of: the system bandwidth or the portion of the system bandwidth, based on the indicator.

15. The method of claim 13, further including:
monitoring, by the UE, in response to the indicator being received dynamically, for the CRS-based downlink grant in one of: a control channel transmitted in the MBSFN subframe where the CRS is transmitted, or the control channel transmitted at least one transmission segment before the MBSFN subframe where the CRS is transmitted, wherein the at least one transmission segment includes at least one of: a subframe, a slot, or a symbol.

16. The method of claim 12, wherein the indicator is received dynamically, the UE is configured in the non-CRS-based transmission mode, and the CRS is transmitted over the system bandwidth, the method further including:
receiving, by the UE, a downlink grant for data transmissions in the MBSFN region during the one or more MBSFN subframes; and
rate-matching, by the UE, the data transmissions around the CRS transmissions within the one or more MBSFN subframes.

17. The method of claim 12, wherein the indicator is received dynamically, the UE is configured in the non-CRS-based transmission mode, and the CRS is transmitted over the portion of the system bandwidth, the method further including:
receiving, by the UE, a downlink grant for data transmissions during a set of resources in the MBSFN region within the one or more MBSFN subframes; and
rate-matching, by the UE, the data transmissions around any of the CRS transmissions that overlap the set of resources within the one or more MBSFN subframes.

18. The method of claim 12, wherein the indicator is received dynamically and the UE is configured in the non-CRS-based transmission mode, the method further including:
receiving, by the UE, a downlink grant for data transmissions in the MBSFN region during the one or more MBSFN subframes, wherein the downlink grant includes a trigger for a CRS-based fallback transmission mode;
monitoring, by the UE, for the data transmissions in the MBSFN region during the one or more MBSFN subframes; and
decoding, by the UE, the data transmissions based on the CRS-based transmission mode, in response to the trigger.

19. The method of claim 18, further including:
enabling, by the UE, CRS-based channel estimation in the at least one MBSFN subframe in response to the CRS-based fallback transmission mode, wherein the CRS-based channel estimation is performed over one of: the system bandwidth or the portion of the system bandwidth, based on the indicator.

20. The method of claim 12, further including:
enabling, by the UE, CRS-based channel estimation in the at least one MBSFN subframe when the UE is not scheduled for the downlink transmissions in the one or more MBSFN subframes, wherein the CRS-based channel estimation is performed over one of: the system bandwidth or the portion of the system bandwidth, based on the indicator.

21. An apparatus configured for wireless communication, the apparatus comprising:
at least one processor of a base station; and
a memory coupled to the at least one processor,
wherein the at least one processor is configured:
to determine one or more cell-specific reference signal (CRS)-based downlink transmissions scheduled during a multicast-broadcast single frequency network (MBSFN) subframe of a plurality of MBSFN subframes within a transmission frame for one or more user equipments (UEs), wherein the one or more UEs are configured for a CRS-based transmission mode; and
in response to a determination of no multicast-broadcast transmissions in the MBSFN subframe:
to transmit CRS during a MBSFN region of the MBSFN subframe; and
to transmit the one or more CRS-based downlink transmissions to the one or more UEs.

22. The apparatus of claim 21, further including configuration of the at least one processor:
to signal an identifier identifying transmission of the CRS, wherein the configuration of the at least one processor to transmit the CRS includes configuration of the at least one processor to one of:
transmit the CRS across a system bandwidth; or
transmit the CRS across one or more physical resource blocks (RBs) on which the one or more CRS-based downlink transmissions are transmitted.

23. The apparatus of claim 22, wherein the configuration of the at least one processor to transmit the CRS across the one or more RBs further includes configuration of the at least one processor to transmit the CRS across one or more additional RBs at both edges of the one or more RBs.

24. The apparatus of claim 22, wherein the configuration of the at least one processor to transmit the CRS across one or more RBs includes configuration of the at least one processor to transmit the CRS across a contiguous set of RBs that incorporates the one or more RBs when the one or more RBs are non-contiguous, wherein the contiguous set of RBs spans a lowest RB on which at least a portion of the one or more CRS-based downlink transmissions is transmitted and a higest RB on which at least another portion of the one or more CRS-based downlink transmissions is transmitted.

25. The apparatus of claim 21, further including configuration of the at least one processor:
to determine, by the base station, a subset of MBSFN subframes of the plurality of MBSFN subframes of the transmission frame available for CRS-based transmissions; and
to signal, by the base station, an indicator to all UEs served by the base station, wherein the indicator indicates the subset of MBSFN subframes.

26. An apparatus configured for wireless communication, the apparatus comprising:
at least one processor of a user equipment (UE); and
a memory coupled to the at least one processor,
wherein the at least one processor is configured:
to receive an indicator from a serving base station, wherein the indicator identifies that cell-specific reference signals (CRS) are to be transmitted in a multicast-broadcast single frequency network (MBSFN) region during one or more MBSFN subframes of a transmission frame;
in response to the indicator being received semi-statically, configuration of the at least one processor to one of:
monitor in response to the UE being configured in a CRS-based transmission mode, for downlink transmissions scheduled during the one or more MBSFN subframes; or
refrain in response to the UE being configured in a non-CRS-based transmission mode, from attempted detection of the downlink transmissions during the one or more MBSFN subframes; or
monitor in response to the UE being configured in a non-CRS-based transmission mode, for the downlink transmissions scheduled during the one or more MBSFN subframes based on one of: the CRS-based fallback transmission mode or the non-CRS-based transmission mode with rate-matching around the CRS; and
in response to the indicator being received dynamically, configuration of the at least one processor to monitor for the downlink transmissions scheduled during the one or more MBSFN subframes.

27. The apparatus of claim 26, further including configuration of the at least one processor:
to receive a CRS-based downlink grant for at least one MBSFN subframe of the one or more MBSFN subframes; and
to enable CRS-based channel estimation in the at least one MBSFN subframe.

28. The apparatus of claim 27, wherein the indicator is received dynamically, the UE is configured in the non-CRS-based transmission mode, and the CRS is transmitted over the system bandwidth, the apparatus further including configuration of the at least one processor:
to receive a downlink grant for data transmissions during the one or more MBSFN subframes; and
to rate-match the data transmissions around the CRS transmissions within the one or more MBSFN subframes.

29. The apparatus of claim 27, wherein the indicator is received dynamically, the UE is configured in the non-CRS-based transmission mode, and the CRS is transmitted over the portion of the system bandwidth, the apparatus further including configuration of the at least one processor:
to receive a downlink grant for data transmissions during a set of resources within the one or more MBSFN subframes; and
to rate-match the data transmissions around any of the CRS transmissions that overlap the set of resources within the one or more MBSFN subframes.

30. The apparatus of claim 27, wherein the indicator is received dynamically and the UE is configured in the non-CRS-based transmission mode, the apparatus further including configuration of the at least one processor:
to receive a downlink grant for data transmissions during the one or more MBSFN subframes, wherein the downlink grant includes a trigger for a CRS-based fallback transmission mode;
to monitor for the data transmissions during the one or more MBSFN subframes; and
to decode the data transmissions based on the CRS-based transmission mode, in response to the trigger.
